(19) United States
(12) Patent Application Publication
(10) Pub. No.: US 2023/0353647 A1
(43) Pub. Date: Nov. 2, 2023

(54) GENERATION OF AUDIENCE GROUP BY AN ONLINE SYSTEM BASED ON A MULTITASK NEURAL NETWORK

(71) Applicant: Meta Platforms, Inc., Menlo Park, CA (US)

(72) Inventors: Jason Jiawei Liao, Mountain View, CA (US); Divakar D. Balasubramanian, Saratoga, CA (US); Ryan Patrick Batterman, Salinas, CA (US)

(21) Appl. No.: 15/985,532

(22) Filed: May 21, 2018

(51) Int. Cl. G06K 9/62; H04L 29/08; G06F 17/30; G06N 3/04; G06N 3/08

(52) U.S. Cl. CPC G06K 9/6218; H04L 67/22; G06F 17/30867; G06N 3/0454; G06N 3/08; H04L 67/20

(57) ABSTRACT

An online system generates a cluster group and uses membership in the cluster group as an eligibility criteria for presenting a content item. The online system receives a request from a third party system to present the content item and an identification of a target action associated with the content item. The online system also receives information about users who performed a target action and users who performed related actions other than the target action on one or more webpages associated with the third party system. The online system forms a multitask neural network and uses the multitask neural network to train a cluster model based on the received information. The online system applies the cluster model to candidate users who have not performed the target action and determines whether to include a candidate user into the cluster group based on output of the cluster model.

### BACKGROUND

This disclosure relates generally to online systems and, in particular, to generating an audience group for a content item by an online system using a multitask machine learning model such as a neural network.

Online systems have become increasingly prevalent in digital content distribution and consumption, and allow users to more easily communicate with one another. Users of an online system associate with other online system users, forming a web of connections. Additionally, users may share personal information and other stories with other users connected to them via an online system. Examples of information shared by online system users include videos, music, contact information, background information, job information, interests, photos, notes, and/or other member-specific data.

An online system stores content items, such as video files, audio files, pictures, documents, etc., for presenting to users of the online system. These content items can be created by the online system, uploaded by online system users, or received from third parties. Online system users may interact with content items presented to them in various ways. For example, an online system user may play, express preference, comment on, share, hide or leave videos presented to them. An online system user can also decide what content item to share with other users connected to the user at the online system, e.g., through a newsfeed of the user.

Third parties that provide content of their interest for presentation by online systems often provide information for identifying online system users to whom the content is presented. Online systems have attempt to leverage presentation of the content by expanding audience of the content to include online system users who are not identified by the third parties but are similar to the online system users identified by the third parties. However, current methods of expanding audience is limited by amount of information provided by the third parties.

### SUMMARY

An online system presents content to one or more of its users, where the content may be provided by a third-party system. The online system generates a cluster group of its users as an audience for the content. Membership in the cluster group may then be used as an eligibility criteria in a content selection process for presenting the content to one or more users of the online system. For example, the online system may provide the content only to users who are in the cluster group, where the cluster group defines a target audience for the content item.

In embodiments of the invention, the online system receives information that a set of users each performed a target action. This information may be received from a third-party system or directly from the user, e.g., a request from the user's browser in response to rendering a tracking pixel. The online system also receives information from client devices associated with users who have visited one or more webpages associated with the third party system. The information includes identification information for the users and related actions performed by the users on the one or more webpages. The online system includes each of the users who performed the target action in a custom audience, which can then be used to define an audience for the content item.

The group of users in the custom audience may be small relative to the user population, and it may be desirable to expand the custom audience to generate a larger audience for the content item, where the audience still has similar attributes as those of the custom audience. To expand the audience, the online system uses the custom audience group as a seed for a cluster expansion algorithm. In various embodiments, the expanded cluster group is obtained by applying a machine learning model to score additional users for inclusion into the expanded group. However, in cases where the target action is relatively uncommon, there may be relatively few users who have performed the action and thus relatively little training data for training the cluster model. Accordingly, the online system uses a multitask neural network for the cluster expansion model. The multitask neural network includes a set of shared layers, a set of layers for predicting the target action, and a set of layers for predicting one or more related actions other than the target action. In this example, there is relatively more data for the related action than the target action and thus more training data. This allows the related actions to help train a model that predicts the target action, where the set of layers for predicting one or more related actions help to generate a rough prediction, and the set of layers for predicting the target action fine tune the prediction for the target action.

To train the multitask neural network, the online system uses a primary training set to backpropagate through the set of layers for predicting the target action and the set of shared layers and uses a secondary training set to backpropagate through the set of layers for predicting the target action and the set of shared layers. The primary training set includes information about the users who performed the target action. The secondary training set includes information about the users who performed one of the related actions other than the target action. The online system samples from the primary and secondary training sets according to a ratio of the number of training examples in each set. For example, if the primary set has 10,000 examples and the secondary training set has 10 million examples, the online system selects from the primary set about 0.1% of the time and otherwise selects from the secondary set, repeating this sampling after each backpropagation of the model. During deployment, the system may use only the shared layers and the set of layers for predicting the target action.

One the model is trained, the online system applies the trained cluster model to one or more characteristics of each candidate user during the cluster expansion process. Candidate users are users of the online system who are not included in the custom audience group. The cluster model outputs a cluster score for each candidate user indicating a similarity of the candidate user to the users of the custom audience group. The online system determines whether to include the candidate user in a cluster group for the content item based on the user's cluster score. For example, the online system includes a candidate user in the cluster group based on the candidate user's cluster score at least equal to a cluster group cutoff score.

### BRIEF DESCRIPTION OF THE DRAWINGS

FIG. 1 is a block diagram of a system environment in which an online system operates, in accordance with an embodiment.

FIG. 2 is a block diagram of an online system in which a cluster group generator operates, in accordance with an embodiment.

FIG. 3 is a block diagram of the cluster group generator, in accordance with an embodiment.

FIG. 4 illustrates an example of training a cluster model by using a multitask neural network, in accordance with an embodiment.

FIG. 5 is a flowchart illustrating a process of generating a cluster group based on a multitask neural network, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

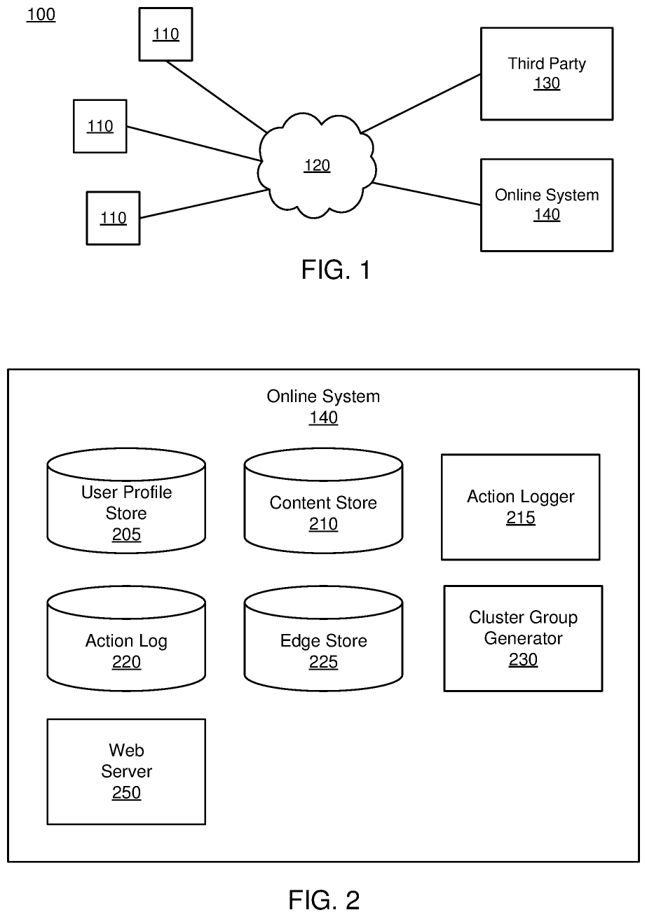

FIG. 1 is a block diagram of a system environment 100 in which an online system 140 operates, in accordance with an embodiment. The system environment 100 shown by FIG. 1 comprises one or more client devices 110, a network 120, one or more third-party systems 130, and the online system 140. In alternative configurations, different and/or additional components may be included in the system environment 100. For example, the online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™. In some embodiments, a client device 110 executes a software module that plays videos. The software module allows the user to play, pause, or leave a video.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

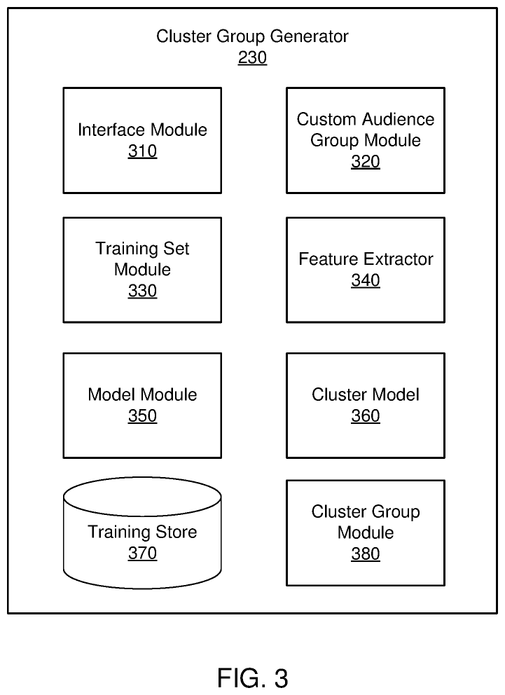

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

For example, a third party system 130 provides primary content for presentation by the online system 140 to a client device 110. As another example, a third party system 130 provides secondary content to be inserted into primary content presented by the online system 140 to a client device 110. Example primary and secondary content includes video, audio, music, text, images, or any combination thereof. In some embodiment, secondary content includes advertisements, e.g., for advertising a brand, product, or service associated with the third party system 130. The third party system 130 may compensate the online system 140 for inserting the secondary content into the primary content. More details regarding primary content and secondary content are described in conjunction with FIG. 2.

FIG. 2 is a block diagram of the online system 140 in which a secondary content module 230 operates. The online system 140 shown in FIG. 2 includes a user profile store 205, a content store 210, an action logger 215, an action log 220, an edge store 225, a secondary content module 230, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects. Each of the objects represents various types of content. Examples of content represented by an object include a page post, a status update, a photograph, a video, an audio, a link, a shared content item, a gaming application achievement, a check-in event at a local business, a brand page, or any other type of content. Content stored in the content store 310, regardless of its composition, may be referred to herein as one or more “content items,” or as “content.” The content store 210 may also store information describing or otherwise related to the content.

Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140. Content items can be presented, e.g., through newsfeed, to an online system user and other online system uses that are connected to the online system user.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were interacted, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140. Edges may connect two users who are connections in a social network, or may connect a user with an object in the system. In one embodiment, the nodes and edges form a complex social network of connections indicating how users are related or connected to each other (e.g., one user accepted a friend request from another user to become connections in the social network) and how a user is connected to an object due to the user interacting with the object in some manner (e.g., “liking” a page object, joining an event object or a group object, etc.). Objects can also be connected to each other based on the objects being related or having some interaction between them.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The cluster group generator 230 generates a cluster group for a content item, the membership of which can be used as an eligibility criteria in a content selection process for the content item. In some embodiments, the cluster group generator 230 receives a request from a third party system to present a content item to users of an online system. The cluster group generator 230 also receives messages from client devices associated with a plurality of online system users who have visited one or more webpages associated with the third party system. The messages include identification information associated with the users and a plurality of related actions performed by the users on the one or more webpages. One of the plurality of related actions is a target action associated with the content item that is identified by the third party system.

Examples of the target action include a purchase of a product associated with content item, an attempted purchase of a product associated with the content item, an expression of interest of a product associated with the content item, or some combination thereof. Examples of the related action include a purchase on a webpage associated with the third party system, an attempted purchase on a webpage associated with the third party system, an express expression of interest in webpage associated with the third party system, or some combination thereof. In one embodiment, the related actions include a type of action corresponding to a same product as the target action. In an alternative embodiment, the related actions include a type of action corresponding to related products associated with the third party system. For example, the target action is a purchase of a Nikon D60 camera and the related actions include purchase of any cameras associated with the third party system.

The cluster group generator 230 identifies online system users who have performed the target action associated with the content item and include these online system users in a custom audience group for the content item. In one embodiment, to define a custom audience, the third party system 130 provides a list of users that it would like to include in a custom audience to the online system 140, which list may be obfuscated by a one-way hash to protect users' personal information. This embodiment is described in U.S. application Ser. No. 13/306,901, filed Nov. 29, 2011, which is incorporated by reference in its entirety. In another embodiment, the custom audience is populated by users who perform actions online, and those actions cause the users' devices 110 to redirect to the online system 140. The online system then obtains these users' identities and adds them to a custom audience. This embodiment is described in U.S. application Ser. No. 14/177,300, filed Feb. 11, 2014, which is incorporated by reference in its entirety.

The cluster group generator 230 performs a lookalike expansion algorithm on a seed group of users to obtain a larger group of users who share characteristics with the seed group. In embodiments of the invention, the specified custom audience is used as the seed group for the lookalike expansion, thereby generating a larger group of users of the online system 140 who are similar to the custom audience specified by the third party system 130. Embodiments of lookalike expansion algorithms in batch processes and in real-time are described in U.S. application Ser. No. 13/297,117, filed Nov. 15, 2011, and U.S. application Ser. No. 14/290,355, filed May 29, 2014, each of which is incorporated by reference in its entirety. Further, the lookalike expansion may be weighted according to the weights specified by the third party system 130 for each user in the custom audience group, which gives the third party system 130 greater ability to shape the resulting expanded audience by specifying which users are more representative of the desired audience. Embodiments of lookalike expansion algorithms using weights are described in U.S. application Ser. No. 15/068,526, filed Mar. 11, 2016, which is incorporated by reference in its entirety.

The cluster group generator 230 expands the custom audience group to a cluster group for the content item by using a cluster model trained with a multitask neural network. For example, the cluster group generator 230 trains the cluster model by forming a multitask neural network that comprises a set of shared layers, a set of layers for predicting the target action, and a set of layers for predicting one or more of the related actions other than the target action. The cluster group generator 230 identifies a primary training set including information about the users who performed the target action based on the received messages and uses the primary training set to backpropagate through the set of layers for predicting the target action and the set of shared layers. Also, the cluster group generator 230 identifies a secondary training set that includes information about the users who performed one of the related actions other than the target action and uses the secondary training set to backpropagate through the set of layers for predicting the target action and the set of shared layers. Parameters of the trained multitask neural network are stored. The trained cluster model is configured to determine a cluster score of an online system user who is not in the custom audience group based on one or more characteristics of the online system user. The cluster score indicates a similarity of the online system user to the users in the custom audience group. The one or more characteristics of a user include at least one of the following: hobbies or preferences, location, age, gender, educational background, work experience, historical actions of the user, connections associated with the user on the online system, or any combination thereof.

Embodiments of training and using a multitask neural network for predicting less common events using training data for more common events are described in U.S. application Ser. No. 15/469,550, entitled “Multi-Task Neutral Network for Feed Ranking,” filed Mar. 26, 2017, and U.S. application Ser. No. 15/784,002, entitled “Flexible Multi-Task Neutral Network for Content Ranking,” filed Oct. 13, 2017, each of which is incorporated by reference in its entirety.

The cluster group generator 230 identifies candidate users who are not in the custom audience group and applies the trained cluster model to one or more characteristics of each candidate user. Further, the cluster group generator 230 determines whether to include a candidate user in a cluster group based on the candidate user's cluster score. For example, the cluster group generator 230 determines to include a candidate user in a cluster group based on the candidate user's cluster score exceeding a cluster group cutoff score. Membership in the cluster group can be used as an eligibility criteria in a content selection process for the content item for presentation to one or more of the users of the online system. More details about the cluster group generator 230 are described in conjunction with FIG. 3.

The web server 240 links the online system 140 via the network 120 to the one or more client devices 110, as well as to the one or more third party systems 130. The web server 240 serves web pages, as well as other content, such as JAVA®, FLASH®, XML and so forth. The web server 240 may receive and route messages between the online system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as JOS®, ANDROID™, or BlackberryOS.

### Cluster Group Generation

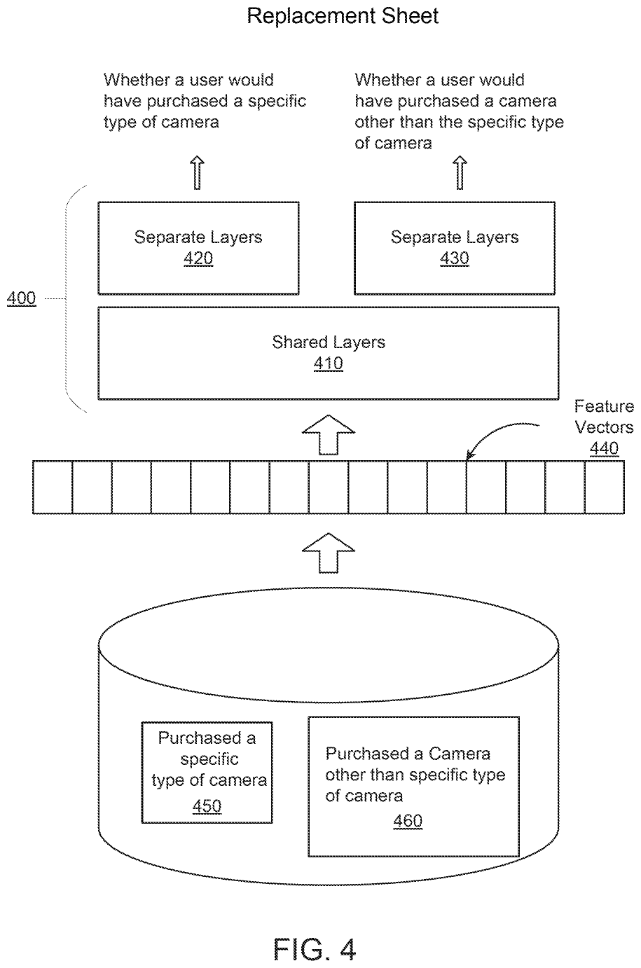

FIG. 3 is a block diagram of the cluster group generator 230, in accordance with an embodiment. The cluster group generator 230 in the embodiment of FIG. 4 includes an interface module 310, a model store 420, a feature extractor 340, a training set module 330, a model module 350, and a cluster module 480. In other embodiments, the cluster group generator 230 may include additional, fewer, or different components for various applications.

The interface module 310 facilitates communication of the secondary content module 230 with other entities. For example, the interface module 310 receives a request from a third party system to present a content item to users of an online system and an identification of a target action associated with the content item. Examples of the target action include a purchase associated with content item, an attempted purchase associated with the content item, an expression of interest in the content item, a share of the content item, or some combination thereof. Also, the interface module 310 receives also receives messages from client devices associated with a plurality of online system users who have visited one or more webpages associated with the third party system. The messages include identification information associated with the users and a plurality of related actions performed by the users on the one or more webpages. One of the plurality of related actions is a target action associated with the content item that is identified by the third party system. Examples of the related action include a purchase on a webpage associated with the third party system, an attempted purchase on a webpage associated with the third party system, an express expression of interest in webpage associated with the third party system, or some combination thereof. In some embodiments, the interface module 310 receives the request and messages from the web server 240.

The interface module 310 can further sends information to other components of the cluster group generator 230 for generating a cluster group for the content item. For example, the interface module 310 sends the identification of a target action associated with the content item and the received messages to the custom audience group module 320 for identifying custom audience for the content item. The interface module 310 can also send the received messages to the training set module 330 for identifying training sets.

The custom audience group module 320 generates a custom audience group of online system users that includes custom audience for the content item. Custom audience for the content item include users who have performed the target action identified by the third party system. In some embodiments, the custom audience group module 320 identifies online system users who have performed the target action associated with the content item based on the identification information associated with the users that is included in the messages received from the client devices of the users. For example, the messages include an email address associated with each user who have performed the target action. The custom audience group module 320 identifies a user by associating the email addresses with an ID of the user on the online system 140. The custom audience group module 320 further includes the identified users in the custom audience group as custom audience for the content item.

The training set module 330 generates a primary training set and a secondary set for training a cluster model. The primary training set includes information about the users who have performed the target action based on the received messages. For example, the primary training set includes a plurality of primary inputs. Each primary input includes a label indicating that a user has performed the target action and a feature vector representing the user. The secondary training set includes information about the users who performed one of the related actions other than the target action. For example, the secondary training set includes a plurality of secondary inputs. Each secondary input includes a label indicating that a user has performed a related action and a feature vector representing the user.

The feature extractor 340 derives feature vectors of the users who have performed one of the related actions. A feature vector of a user represents one or more characteristics of the user. Examples characteristics of a user include hobbies or preferences, location, age, gender, educational background, work experience, or historical actions of the user, connections associated with the user on the online system, or any combination thereof.

The model module 350 trains a cluster model by forming a multi-task neural network. The multitask neural network includes a plurality of layers and a plurality of parameters to be trained. For example, the multitask neural network includes a set of shared layers, a set of layers for predicting the target action, and a set of layers for predicting one or more of the related actions other than the target action. The model module 350 uses the primary training set to backpropagate through the set of layers for predicting the target action and the set of shared layers. For example, the model module 350 inputs a primary input of the primary training set into the set of layers for predicting the target action and the set of shared layers and receives an output indicating whether the user has performed the target action. When the output is inconsistent with the label in the primary input, the model module 350 determines one or more errors in parameters corresponding to the set of layers for predicting the target action and the set of shared layers and adjusts the parameters accordingly. The model module 350 may continue this process until output of the set of layers for predicting the target action and the set of shared layers is consistent with labels in the primary inputs of the primary training set. Similarly, the cluster group generator 230 uses the secondary training set to backpropagate through the set of layers for predicting one or more related actions other than the target action and the set of shared layers. The model module 350 adjusts parameters of the set of layers for predicting the one or more related actions other than the target action and the set of shared layers till output of the set of layers for predicting the one or more related actions other than the target action and the set of shared layers is consistent with labels in secondary inputs of the secondary training set. Parameters of the set of shared layers, a set of layers for predicting the target action, and a set of layers for predicting one or more of the related actions other than the target action are stored in the training store 360.

The cluster model 360 includes the set of shared layers, a set of layers for predicting the target action, and their corresponding parameters. The cluster model 360 can receive a feature vector representing a user and predict whether the user would have performed the target action if the content item is presented to the user. For example, the cluster model 360 outputs a cluster score representing a likelihood of the user performing the target action. The cluster score indicates a similarity of the user to the users of the custom audience group.

In some embodiments, the model module 350 trains the cluster model 360 based one or more training algorithms. Examples of training algorithms may include mini-batch-based stochastic gradient descent (SGD), gradient boosted decision trees (GBDT), SVM (support vector machine), neural networks, logistic regression, naïve Bayes, memory-based learning, random forests, decision trees, bagged trees, boosted trees, or boosted stumps. More details regarding training the cluster model 360 are described in conjunction with FIG. 4.

The cluster group module 380 identifies candidate users for including in a cluster group for the content item and applies the cluster model to one or more characteristics of each candidate user to determine whether to include the candidate user in the cluster group. For each candidate user of a plurality of users of the online system who are not included in the custom audience group, the cluster group generator 230 performs a cluster expansion process. The cluster group generator 230 applies 560 the trained cluster model to the one or more characteristics of the candidate user. The cluster model outputs a cluster score for the candidate user indicating a similarity of the candidate user to the users of the custom audience group.

The cluster group module 380 determines whether to include the candidate user in a cluster group for the content item based on output of the cluster model 360. For example, the cluster group module 380 compares the cluster score for the candidate user with a cluster group cutoff score. The cluster group cutoff score may be determined by the third party system or a privileged user of the online system 140. Based on the cluster score for the candidate user exceeding the cluster group cutoff score, the cluster group module 380 includes the candidate user in the cluster group. In contrast, the cluster group module 380 does not include a candidate user in the cluster group based on a determination that the cluster score for the candidate user below or equal to the cluster group cutoff score.

The cluster group module 380 further uses membership in the cluster group as an eligibility criteria in a content selection process for the content item for presentation to one or more of the users of the online system. In some embodiments, the online system 140 provide the content item for presentation to users in the custom audience group and the cluster group.

FIG. 4 illustrates an example of training a cluster model based on a multitask neural network 400, in accordance with an embodiment. The cluster model is configured to receive a feature vector representing a user and predict whether the user would have purchased a Nikon D60 if a content item is presented to the user. The training process is a multitask learning. The multitask neural network 400 includes a set of shared layers 410 and two sets of separate layers, separate layers 420 associated with the trained task (i.e., predicting whether a user would purchase a Nikon D60) and separate layers 430 associated with non-trained task. The separate layers 430 are not used during deployment of the cluster model, but rather only for training.

The multitask neural network 400 is trained based on two training sets 450 and 460. The training set 450 includes information about users who have purchased a Nikon D60, including a feature vector for each user and a label indicating the user's purchase of a Nikon D60. Because the training set 450 is limited to users who have purchased a specific type of camera (i.e., Nikon D60), the training set 450 may not include enough data to train the cluster model. In contrast, the training set 460 includes a larger amount of data compared with the training set 410, as indicated in FIG. 4. The training set 460 includes information about users who have purchased a camera other than Nikon D60, including a feature vector for each user and a label indicating the user's purchase of a camera other than Nikon D60.

The shared layers 410 may include multiple lower layers that extract common feature vectors 440 across all the tasks (including the trained task and non-trained task). Examples of functions that are performed by the shared layers 410 may include regularizations (e.g., L₁-norm regularization, L₂-norm regularization, low-rank-based regularization, mean-based regularization, etc.), or shared parameter process (e.g., Gaussian process).

The separate layers 420 and 430 may include multiple top layers that use task-specific neurons to realize separate predictions. For example, the layers 420 outputs a prediction of whether a user would purchase a Nikon D60, e.g., a cluster score indicating the prediction, and the layers 430 outputs a prediction of whether a user would purchase a camera other than Nikon D60. In some embodiments, each top layer is associated with a specific task.

During the training process, feature vectors of users included in the training sets 450 are input into the share layers 410 and the separate layers 420. The separate layers output a prediction of whether the user would have purchased a Nikon D60. The prediction is compared with the corresponding label in the training set 450. Inconsistency between the prediction and the label is used for backpropagating through the share layers 410 and the separate layers 420. Also, feature vectors of users included in the training sets 460 are input into the share layers 410 and the separate layers 430. The separate layers output a prediction of whether the user would have purchased a camera other than Nikon D60. The prediction is compared with the corresponding label in the training set 460 for backpropagating through the share layers 410 and the separate layers 430. The trained shared layers 410 and separate layers 420 are used during deployment of the cluster model.

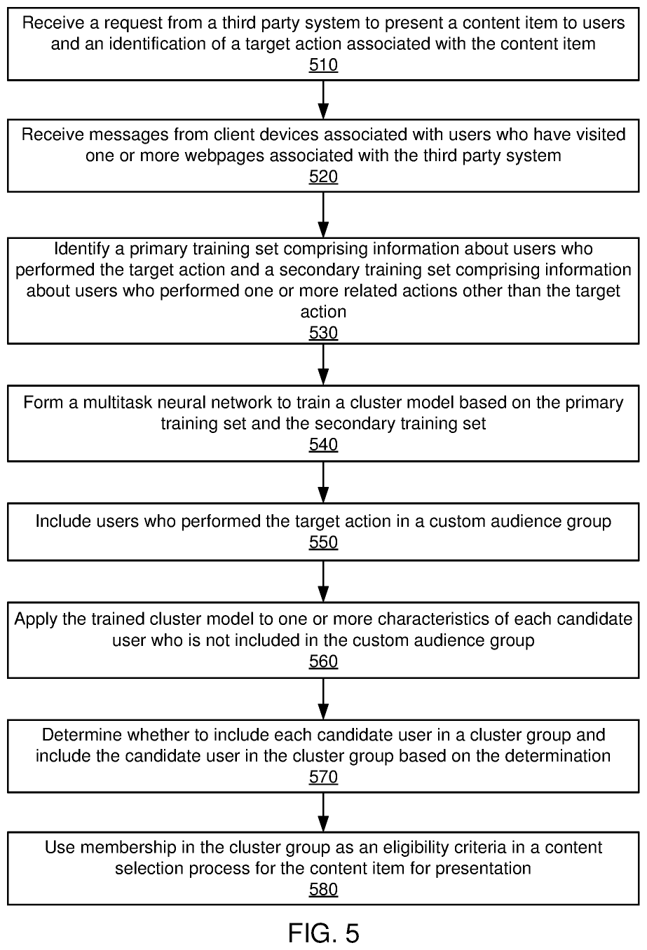

FIG. 5 is a flowchart illustrating a process of generating a cluster group for a content item based on a multitask neural network, in accordance with an embodiment. In some embodiments, the process is performed by the cluster group generator 230, although some or all of the operations in the method may be performed by other entities in other embodiments. In some embodiments, the operations in the flow chart are performed in a different order and can include different and/or additional steps.

The cluster group generator 230 receives 510 a request from a third party system to present a content item to users of an online system and an identification of a target action associated with the content item. An example of the target action is a purchase of a product associated with the content item. The target action can be other types of actions associated with the content item, such as an attempt purchase of a product, an expression of interest, or some combination thereof.

The cluster group generator 230 receives 520 messages from client devices associated with a plurality of users who have visited one or more webpages associated with the third party system. The messages includes identification information associated with the users. The identification information associated with a user includes at least one of the following: a name associated with the user, an email address associated with the user, a physical address associated with the user, a number associated with the user, an image associated with the user, or any combination thereof. The messages also include related actions performed by the users on the one or more webpages. One of the related actions is the target action. The related actions can include types of action corresponding to a same product associated with the third party system as the target action or types of action corresponding to related products associated with the third party system.

The cluster group generator 230 identifies 530 a primary training set comprising information about the users who performed the target action based on the received messages and a secondary training set comprising information about the users who performed one or more related actions other than the target action. The primary training set includes a plurality of primary inputs. Each primary input includes a label indicating that a user has performed the target action and a feature vector representing the user. The secondary training set includes a plurality of secondary inputs. Each secondary input includes a label indicating that a user has performed a related action other than the target action and a feature vector representing the user. A feature vector of a user represents one or more characteristics of the user, including hobbies or preferences, location, age, gender, educational background, work experience, or historical actions of the user, connections associated with the user on the online system, or any combination thereof.

The cluster group generator 230 forms 540 a multitask neural network to train a cluster model based on the primary training set and the secondary training set. The multitask neural network includes a plurality of layers and a plurality of parameters to be trained. For example, the multitask neural network includes a set of shared layers, a set of layers for predicting the target action, and a set of layers for predicting the one or more related actions other than the target action. The cluster group generator 230 uses the primary training set to backpropagate through the set of layers for predicting the target action and the set of shared layers. The cluster group generator 230 uses the secondary training set to backpropagate through the set of layers for predicting the one or more related actions other than the target action and the set of shared layers. Parameters of the trained multitask neural network are stored.

The cluster group generator 230 includes 550 the users who performed the target action in a custom audience group for the content item. For each candidate user of a plurality of users of the online system who are not included in the custom audience group, the cluster group generator 230 performs a cluster expansion process. The cluster group generator 230 applies 560 the trained cluster model to the one or more characteristics of the candidate user. The cluster model outputs a cluster score for the candidate user indicating a similarity of the candidate user to the users of the custom audience group.

The cluster group generator 230 determines 570 whether to include the candidate user in a cluster group for the content item and includes 570 the candidate user in the cluster group based on the determination. For example, the cluster group generator 230 compares the cluster score for the candidate user with a cluster group cutoff score. Based on the cluster score for the candidate user exceeding the cluster group cutoff score, the cluster group generator 230 includes the candidate user in the cluster group.

The cluster group generator 230 uses 580 membership in the cluster group as an eligibility criteria in a content selection process for the content item for presentation to one or more of the users of the online system. In some embodiments, the cluster group generator 230 provides the content item for presentation to users in the custom audience group and the cluster group.

### Additional Embodiments

Embodiments of the invention described herein discuss a neural network instantiation of a multitask model used for generating an audience group for a content item. In other embodiments, other types of machine learning models can be used in place of the multitask neural network described herein. For example, logistic regression models may be used, where one logistic regression model predicts a likelihood that users will click on or otherwise engage with content, and another logistic regression model predicts whether a likelihood that users will make purchases related to that content. These two models could be trained separately, but that training would not benefit from sharing across domains. Instead, in accordance with techniques described herein, the cost functions of the models are updated so that they are penalized in accordance with how distinct their weight vectors are across domains (i.e., the two models). For example, adding a|w1−w2|\hat{ }2 term could push their weights closer together and improve the performance of both models, especially if one had relatively less training data. The logistic regression is just another example, and this kind of cross-domain training can be used in other types of machine learning models as well.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

1. A method comprising:
receiving a request from a third party system to present a content item to users of an online system and an identification of a target action associated with the content item;
receiving messages from client devices associated with a plurality of users who have visited one or more webpages associated with the third party system, the messages including identification information associated with the users and a plurality of related actions performed by the users on the one or more webpages, where one of the plurality of related actions is the target action;
identifying a primary training set comprising information about the users who performed the target action based on the received messages, and a secondary training set comprising information about the users who performed one of the related actions other than the target action;
training a cluster model by:
forming a multitask neural network that comprises:
a set of shared layers comprising a plurality of interconnected layers comprising an input layer and an output layer,
a first set of layers consisting of a plurality of interconnected layers for predicting the target action, wherein the output layer of the set of shared layers is connected to an input layer of the first set of layers, and
a second set of layers consisting of a plurality of interconnected layers for predicting one or more of the related actions other than the target action, wherein the output layer of the set of shared layers is connected to an input layer of the second set of layers,
using the primary training set, backpropagating through the first set of layers and the set of shared layers,
using the secondary training set, backpropagating through the second set of layers and the set of shared layers, and
storing the trained multitask neural network;
including the users who performed the target action in a custom audience group for the content item;
for each candidate user of a plurality of users of the online system who are not included in the custom audience group, performing a cluster expansion process by:
applying the trained cluster model to one or more characteristics of the candidate user, the trained cluster model outputting a cluster score for the user indicating a similarity of the candidate user to the users of the custom audience group,
determining whether to include the candidate user in a cluster group for the content item based on the candidate user's cluster score, and
including the candidate user in the cluster group based on the determination; and
using membership in the cluster group as an eligibility criteria in a content selection process for presenting the content item to one or more of the users of the online system.

2. The method of claim 1, wherein the set of shared layers is configured to extract features that are shared across the plurality of users.

3. The method of claim 1, wherein the first set of layers is configured to extract features that are shared across the users performed the target action.

4. The method of claim 1, wherein the second set of layers is configured to extract features that are shared across the users performed one of the related actions other than the target action.

5. The method of claim 1, wherein the set of shared layers, the first set of layers, and the second set of layers are trained jointly.

6. The method of claim 1, wherein the set of shared layers, the first set of layers, and the second set of layers are trained separately.

7. The method of claim 1, wherein including the candidate user in the cluster group based on the determination comprises:
determining to include the candidate user in the cluster group based on the candidate user's cluster score at least equal to a cluster group cutoff score.

8. The method of claim 1, wherein the plurality of related actions include a type of action corresponding to related products associated with the third party system.

9. The method of claim 1, wherein the plurality of related actions include a plurality of types of action corresponding to a same product associated with the third party system.

10. The method of claim 1, wherein the identification information associated with a user includes at least one of the following: a name associated with the user, an email address associated with the user, a physical address associated with the user, a number associated with the user, an image associated with the user, or any combination thereof.

11. The method of claim 1, wherein the one or more characteristics of the candidate user include at least one of the following: hobbies or preferences, location, age, gender, educational background, work experience, or historical actions of the candidate user, connections associated with the candidate user on the online system, or any combination thereof.

12. A non-transitory computer readable medium storing executable computer program instructions, the computer program instructions comprising instructions that when executed cause a computer processor to:
receive a request from a third party system to present a content item to users of an online system and an identification of a target action associated with the content item;
receive messages from client devices associated with a plurality of users who have visited one or more webpages associated with the third party system, the messages including identification information associated with the users and a plurality of related actions performed by the users on the one or more webpages, where one of the plurality of related actions is the target action;
identify a primary training set comprising information about the users who performed the target action based on the received messages, and a secondary training set comprising information about the users who performed one of the related actions other than the target action;
train a cluster model by:
forming a multitask neural network that comprises:
a set of shared layers comprising a plurality of interconnected layers comprising an input layer and an output layer,
a first set of layers consisting of a plurality of interconnected layers for predicting the target action, wherein the output layer of the set of shared layers is connected to an input layer of the first set of layers, and
a second set of layers consisting of a plurality of interconnected layers for predicting one or more of the related actions other than the target action, wherein the output layer of the set of shared layers is connected to an input layer of the second set of layers,
using the primary training set, backpropagating through the first set of layers and the set of shared layers,
using the secondary training set, backpropagating through the second set of layers and the set of shared layers, and
storing the trained multitask neural network;
include the users who performed the target action in a custom audience group for the content item;
for each candidate user of a plurality of users of the online system who are not included in the custom audience group, perform a cluster expansion process by:
applying the trained cluster model to one or more characteristics of the candidate user, the trained cluster model outputting a cluster score for the user indicating a similarity of the candidate user to the users of the custom audience group,
determining whether to include the candidate user in a cluster group for the content item based on the candidate user's cluster score, and
including the candidate user in the cluster group based on the determination; and
use membership in the cluster group as an eligibility criteria in a content selection process for presenting the content item to one or more of the users of the online system.

13. The computer readable medium of claim 12, wherein the set of shared layers is configured to extract features that are shared across the plurality of users.

14. The computer readable medium of claim 12, wherein first set of layers is configured to extract features that are shared across the users performed the target action.

15. The computer readable medium of claim 12, wherein the second set of layers is configured to extract features that are shared across the users performed one of the related actions other than the target action.

16. The computer readable medium of claim 12, wherein the set of shared layers, first set of layers, and the second set of layers are trained jointly.

17. The computer readable medium of claim 12, wherein the set of shared layers, first set of layers, and the second set of layers are trained separately.

18. The computer readable medium of claim 12, wherein the plurality of related actions include a type of action corresponding to related products associated with the third party system.

19. The computer readable medium of claim 12, wherein the identification information associated with a user includes at least one of the following: a name associated with the user, an email address associated with the user, a physical address associated with the user, a number associated with the user, an image associated with the user, or any combination thereof.

20. The computer readable medium of claim 12, wherein the one or more characteristics of the candidate user include at least one of the following: hobbies or preferences, location, age, gender, educational background, work experience, or historical actions of the candidate user, connections associated with the candidate user on the online system, or any combination thereof.
